(19) United States
(12) Patent Application Publication
(10) Pub. No.: US 2009/0109482 A1
(43) Pub. Date: Apr. 30, 2009

(54) Image processing device and method of the same

(75) Inventor: Hideki Sato, Tokyo (JP)

Correspondence Address: POSZ LAW GROUP, PLC, 12040 SOUTH LAKES DRIVE, SUITE 101, RESTON, VA, 20191, US

(73) Assignee: Oki Data Corporation, Minato-ku, Tokyo (JP)

(21) Appl. No.: 12/285,209

(22) Filed: Sep. 30, 2008

(30) Foreign Application Priority Data
Oct. 30, 2007 (JP) 2007-281266

(51) Int. Cl. G06F 3/12; G06F 15/16

(52) U.S. Cl. 358/1.15; 709/206

(57) ABSTRACT

An image processing device comprises an operation module configured to input designation settings of a designated transmission destination of image data, an approved transmission destination information storage sector configured to store approved transmission destination information including transmission destinations that have been approved for receiving the image data, and a controller configured to control transmission of the image data by comparing the designated transmission destination received at the operation module and the transmission destinations stored in the approved transmission destination information storage sector.

### CROSS REFERENCE TO RELATED APPLICATION

The present application claims priority to Japanese Patent Application No. 2007-281266, filed on Oct. 30, 2007, the contents of which are incorporated by reference.

### TECHNICAL FIELD

The invention relates generally to image processing, and particularly to an image processing device for enabling image data to be transmitted via email only by authenticated (or approved) persons and/or only to approved destinations.

### BACKGROUND

Conventionally, devices having the functionality to send documents scanned by a scanner as image data via email are known.

However, with such devices, typically anyone can send an email with a data attachment. As a result, employees within a company can easily send emails with image data attachments to unauthorized persons outside of the company, thereby possibly leading to unauthorized disclosure of confidential or otherwise sensitive company information.

In view of the above-mentioned circumstances, there is a need for an image processing device that can restrict the destinations to which image data can be transmitted and that can restrict image data transmission rights to only persons authenticated or approved to transmit such data.

### SUMMARY

Consequently, an image processing device and associated method for transmitting image data are provided that can restrict the destinations to which image data can be transmitted and that can restrict image data transmission rights to only persons authenticated or approved to transmit such image data.

An image processing device includes an operation module configured to input designation settings of a designated transmission destination of image data and an approved transmission destination information storage sector configured to store approved transmission destination information including transmission destinations that have been approved for receiving the image data. A controller is configured to control transmission of the image data by comparing the designated transmission destination with transmission destinations stored in the approved transmission destination information storage sector.

When the transmission destination of image data designated by an image data sender does not match any of the stored transmission destinations, the controller can determine whether the image data sender has been approved to transmit image data based on authentication information of the image data sender that is read by the authentication information reader. Moreover, because approved transmission destinations are stored, a controller can determine whether the transmitting destination that is designated by the image data sender matches one of the stored transmission destinations.

More specifically, an approved sender information storage sector is configured to store authentication information for senders who are approved to transmit image data. When the email transmission destination designated by the image data sender and a stored transmission destination do not match, the controller can request authentication of the sender.

According to the disclosed exemplary embodiments of an image processing device, the image data sender can transmit the image data only to approved transmission destinations. Moreover, because a person who is not authorized by the image processing device to transmit image data cannot transmit image data, it is possible to prevent unauthorized transmission of data, thereby enhancing overall data security.

### BRIEF DESCRIPTION OF THE DRAWINGS

FIG. 1 is a diagram of an exemplary network structure in which a multi-function peripheral (MFP) according to various exemplary embodiments is implemented.

FIG. 2 is a block diagram of the MFP shown in FIG. 1.

FIG. 3 is a diagram showing one example of approved transmission destination information, including transmission destination addresses not requiring approval and stored in the MFP of FIG. 2.

FIG. 4 is a diagram showing one example of approved email sender information stored in the MFP of FIG. 2.

FIG. 5 is an explanatory diagram showing one example of a transmission log of the MFP of FIG. 2.

FIG. 6 is a flow diagram illustrating mail transmission processing executed by the MFP of FIG. 2.

FIG. 7 shows an exemplary operation panel of the MFP of FIG. 2.

FIG. 8 is an exemplary illustration of a screen shot from a display of the MFP of FIG. 2 showing an exemplary message for requesting authentication of an email sender.

FIG. 9 is an exemplary illustration of a screen shot from the display of the MFP of FIG. 2 showing an exemplary message for non-approved email transmission.

FIG. 10 shows one example of approved email sender information stored in the MFP of FIG. 2.

FIG. 11 shows an exemplary transmission log of the MFP of FIG. 2.

FIG. 12 is a flow diagram illustrating mail transmission processing executed by the MFP of FIG. 2.

FIG. 13 is a flow diagram illustrating authentication processing executed by the MFP of FIG. 2.

FIG. 14 is an exemplary illustration of a display of the MFP of FIG. 2 showing an exemplary message requesting approval of a person authorized to approve email transmission.

### DETAILED DESCRIPTION

An image processing device according to various exemplary embodiments will be explained with reference to diagrams hereafter. The foregoing embodiment of an exemplary image processing device is explained with reference to image data created based on a document read by a Multi Function Peripheral (MFP) and transmitted as an email attachment.

Moreover, the instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued. It is further understood that the use of relational terms such as first and second, and the like, if any, are used solely to distinguish one from another entity, item, or action without necessarily requiring or implying any actual such relationship or order between such entities, items or actions.

It is noted that some embodiments may include a plurality of processes or steps, which can be performed in any order, unless expressly and necessarily limited to a particular order; i.e., processes or steps that are not so limited may be performed in any order. Much of the inventive functionality and many of the inventive principles when implemented, are best supported with or in software or integrated circuits (ICs), such as a digital signal processor and software therefore, and/or application specific ICs, or a combination thereof.

It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

### First Embodiment

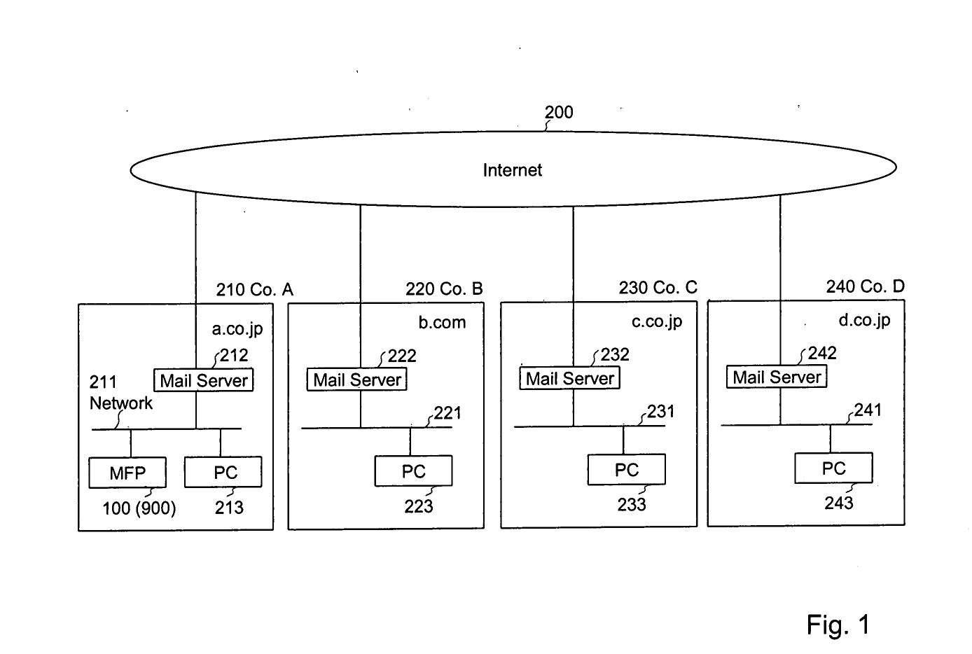

FIG. 1 shows an exemplary network in which a multi-function peripheral (MFP) 100 (900) is connected. The reference number 900 is shown in parentheses as it references that portion of a second embodiment that will be discussed in detail below. More specifically, FIG. 1 shows how a company, identified in FIG. 1 as Company A and by reference number 210, has installed MFP 100. FIG. 1 also shows additional companies, such as the companies identified as Company B, Company C and Company D and by reference numbers 220, 230 and 240, respectively, can transmit emails using MFP 100. As will be discussed in more detail below, Company B 220 is a group company of Company A 210 where all of the employees of Company A 210 are permitted to send emails to Company B 220 using MFP 100. Company C 230 and Company D 240 do not have a special contract with Company A 210 and therefore only certain specified employees of Company A are permitted to transmit emails to Company C 230 and Company D 240 using MFP 100.

Regarding MFP 100, a mail server 212 controls emails of Company A 210 and a personal computer 213 may be used to send and receive emails from the mail server 212, both of which are connected to the network 211 of Company A via a Local Area Network (LAN). A mail server 222 controls emails of Company B 220 and a personal computer 223 may be used to send and receive emails from the mail server 222, both of which are connected to a network 221 of Company B via a LAN. A mail server 232 and a personal computer 233 are connected to a network 231 of Company C 230 via a LAN. A mail server 242 and a personal computer 243 are connected to a network 241 of Company D 240 via a LAN. The networks 211, 221, 231 and 241 together form an overall communications network by being connected through the Internet 200. Each company can send and receive emails over the Internet 200.

Employees of Company A 210 can send emails using MFP 100 without an approval process within Company A 210 and to Company B 220, which is a group company of Company A. For example, when the transmission destination of an email transmitted using MFP 100 by an employee of Company A 210 is within Company A 210, other employees of Company A 210 can access the email that was transmitted by the mail server 212 by accessing the mail server 212 from devices such as the personal computer 213 within the company. Moreover, when the transmission destination of the email that was transmitted using MFP 100 by an employee of Company A 210 is Company B 220, the email transmitted to the mail server 212 will be transferred to a mail server 222 of Company B 220 via the Internet 200. Employees of Company B 220 can receive the emails by accessing the mail server 222 from devices within Company B 220 such as a personal computer 223.

On the other hand, with respect to Companies C 230 and D 240, only specified employees of Company A 210 who are approved to transmit emails can transmit emails using MFP 100. Accordingly, the employees who are not approved to transmit emails using MFP 100 cannot transmit emails to Companies C 230 and D 240.

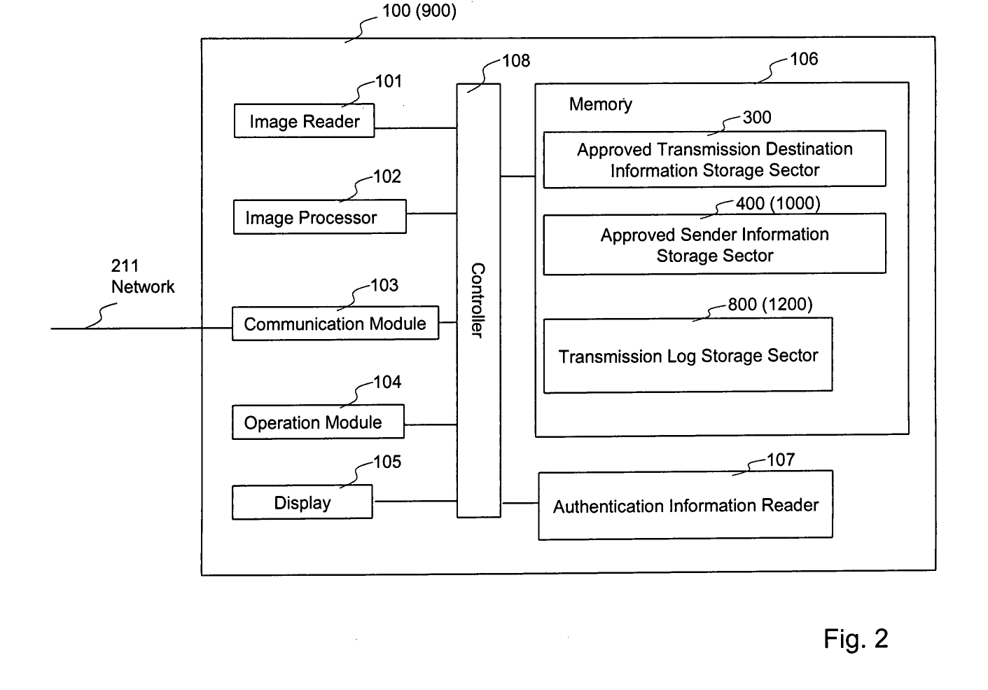

Referring now to FIG. 2, MFP 100 includes an image reader 101, an image processor 102, a communication module 103, an operation module 104 for designating a transmission destination, a display 105, a memory 106, an authentication information reader 107 and a controller 108.

The memory 106 further includes an approved transmission destination information storage sector 300, an approved sender information storage sector 400 (1000) and a transmission log storage sector 800 (1200). The reference numbers 1000 and 1200 are shown in parentheses as they reference portions of a second embodiment that will be discussed in detail below.

The image reader 101 is a unit, such as a scanner, that is configured to read and scan images of a plurality document pages fed into the image reader 101 using a plain-surface scanning reader and an Auto Document Feeder (ADF). Thus, images to be attached to emails and to be transmitted by the computer 213 can be created by the image reader 101.

The image processor 102 is configured to convert images read at the image reader 101 into image data files. For example, the image processor 102 may convert scanned images into a Portable Document Format (PDF) file or Tagged Image File Format (TIFF) file.

The communication module 103 configures the transmission destination address input at the operation module 104 as an email transmission destination, creates the email to which the image data file created at the image processor 102 is attached and transmits the email to the transmission destination address.

The communication module 103 is connected to the network 211 of Company A 210 via a network interface (not shown) to communicate with the mail server 212 using the Internet Protocol (IP) address of the mail server 212 that is stored in advance in the memory 106.

The operation module 104 is configured to receive designation settings of designated transmission destinations necessary for email transmission, and executes email transmissions. The operation module 104 includes input means such as keys, a touch panel or the like for enabling the designation settings to be input. Moreover, the display 105 is a Light Emitting Diode (LED) type display, a Liquid Crystal Display (LCD) or the like and displays messages for requesting authentication of transmission destination addresses, email transmission titles, and email senders at the operation module 104, etc. and as will be described in more detail below.

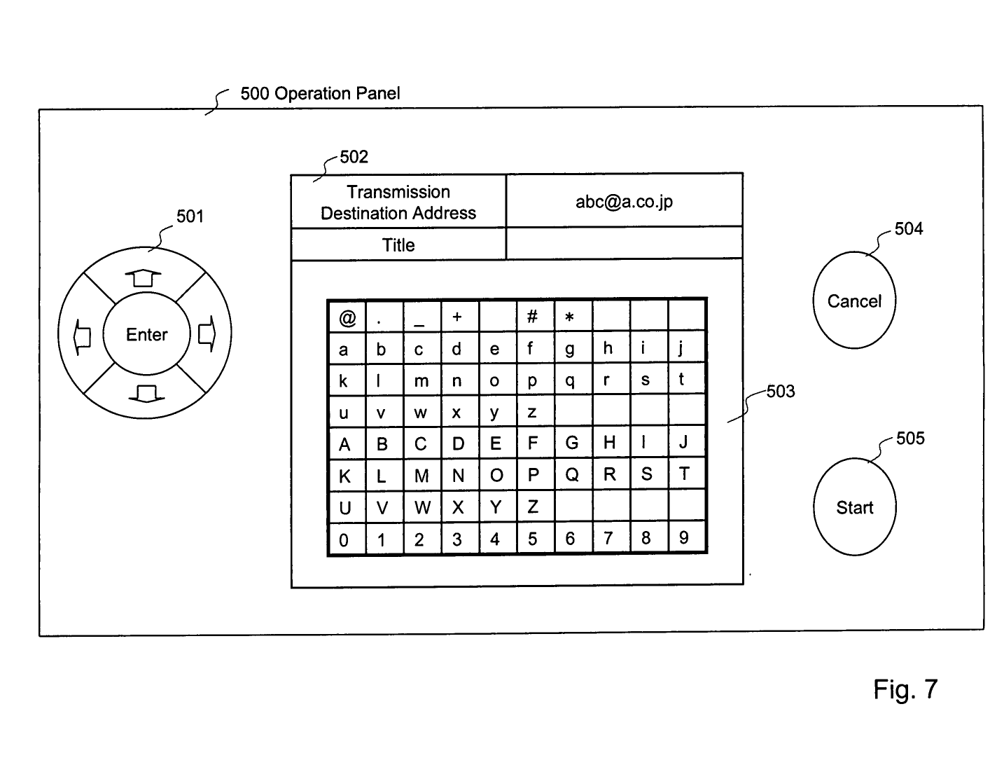

Referring now to FIG. 7, according to the first embodiment, the operation module 104 and the display 10 are integrated as a single unit, and shown as an operation panel 500. However, they can be configured as separated units. The operation panel 500 includes a display panel 503, which displays lists of characters, numbers and symbols used for inputting the transmission destination addresses or the like or messages which will be explained below. The operation panel 500 also includes up-down-left-right keys and an enter key, shown at 501, which determine movement of the cursor to, and selection of, the input characters. The transmission destination addresses and the title of the email, shown at 502, are input using the up-down-left-right keys and the enter key 501. Instructions for reading the document are entered by pressing a start key 505 after the input described above is completed. Moreover, the document reading is canceled when a cancel key 504 is pressed.

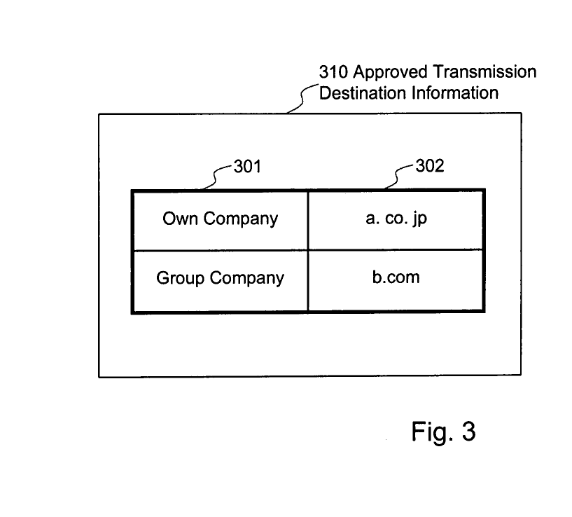

As shown in FIG. 3, at the approved transmission destination information storage sector 300 of the memory 106, approved transmission destination information 310 is registered. More specifically, information including transmission destination addresses that do not require authorization at the time of sending emails is stored in the approved transmission destination information storage sector 300.

The approved transmission destination information 310 is structured with registered names 301 of the email transmission designations and transmission destination addresses 302 to which emails can be unconditionally transmitted. For example, the domain name “a.co.jp” of Company A and the domain name “b.com” of Company B 220, which is a company within the group of Company A, are registered as transmission destination addresses 302. However, when the transmission destinations need to be limited, for example, specific email addresses, such as abc@a.co.jp, can be registered. Moreover, the designation of the transmission destinations need not be limited to the domain names of the email addresses. The domain name of the FTP (File Transfer Protocol) server can be registered when the data file is transmitted using FTP. Also, the registration of the approved transmission destination information 310 can be done via the network using the operation module 104 and the webpage of the MFP 100.

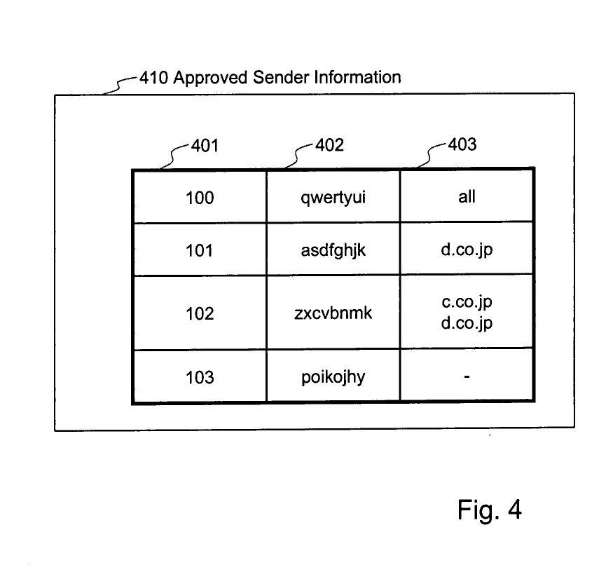

As shown in FIG. 4, at the approved sender information storage sector 400 of the memory 106, approved sender information 410 is registered. The approved sender information 410 includes email sender identification (ID) codes 401, email sender ID codes 402, and individual destination email addresses 403 to which email senders who have been approved to send emails can send emails. The email sender ID codes 401 are identification codes for each email sender such as an employee number. The email sender ID codes 402 are identification codes used for authenticating the email senders. Also, when fingerprint authentication is used at the identification information reader 107, the fingerprint information will be registered as the ID codes for the email senders.

The individual destination email addresses 403 are stored as a list of the email addresses that are approved for each email sender to send emails with the attached data files that were created at MFP 100. When “all” is registered in the individual destination email addresses 403, it means that the email senders using MFP 100 are approved to send emails to any destinations. Moreover, when only the domain of, for example, [d.co.jp] is registered, the email senders using MFP 100 are only approved to transmit emails to Company D 240, and not approved to transmit emails to other companies such as Company C 230. Moreover, when no domains are registered to the individual destination email addresses 403, the email senders using MFP 100 cannot transmit emails to either Company C or Company D.

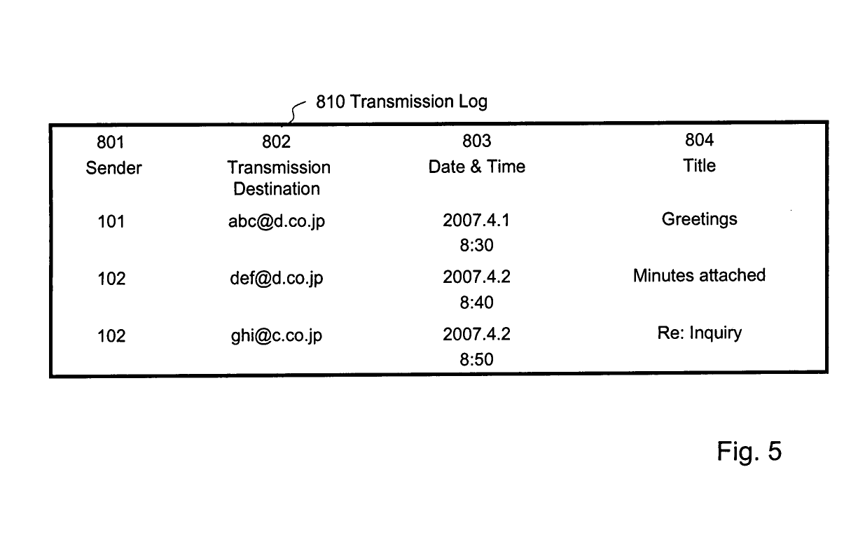

As shown in FIG. 5, a transmission log 810 is stored at the transmission log storage sector 800 of the memory 106 when emails are transmitted to the approved transmission destinations. For example, information on senders 801, transmission destinations 802, transmission times and dates 803 and email titles 804 or the like are stored in the transmission log 810.

Returning to FIG. 2, the authentication information reader 107 is configured to read the email sender information. For example, it may be configured to read an IC card, fingerprints or the like of the email sender and to obtain the identification code of the email sender.

The controller 108 includes a Central Processing Unit (CPU), a Read Only Memory (ROM), a Random Access Memory (RAM) or the like, none of which are shown. The CPU is structured with a microprocessor to control the MFP 100 by executing a program or programs stored in the ROM. The ROM is structured with nonvolatile memories such as a flash memory, an Ultra-Violet Erasable Programmable Read Only Memory (UV-EPROM) and an Electronically Erasable and Programmable Read Only Memory (EEPROM), and stores the control program of MFP 100.

Moreover, the RAM is structured with a Dynamic RAM (DRAM), Synchronous DRAM (SDRAM) or the like, and is used as a first memory area for program execution.

Hereafter, the operation of MFP 100 will be explained. At the MFP 100, necessary information for MFP 100 to communicate with the mail server 212, such as an IP address of the server 212, is registered by the administrator in the memory 106. Also, the approved transmission destination information 310 and the approved sender information 410 for the transmission destination addresses for which approval of the email senders is unnecessary, is registered in MFP 100.

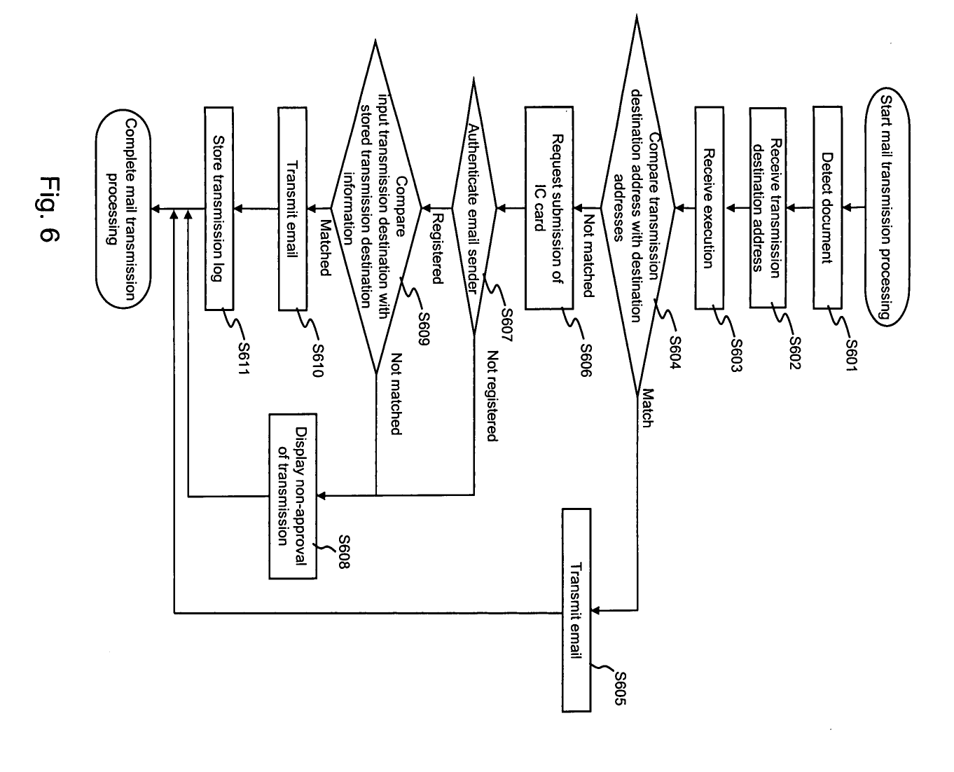

FIG. 6 is a flow diagram illustrating email transmission processing beginning with the reading of documents at the image reader 101 of MFP 100 through transmission of emails.

When the image reader 101 of MFP 100 detects the documents are set by an email sender (S601), the controller 108 starts the preparation to receive the transmission destination address(es) input by the email sender (S602). When the transmission destination address is input by the email sender in the address input field 502 of the operation panel 500 shown in FIG. 7, and the start key 505 of the operation panel 500 is pressed, the controller 108 prepares to read the documents set by the email sender (S603).

Next, the controller 108 compares the transmission destination address input by the email sender with the transmission destination addresses that are registered in the approved transmission destination information storage sector 300 in order (S604). As a result, when the transmission destination address input by the email sender and one of the transmission destination addresses that are registered in the approved transmission destination information storage sector 300 match (S604: Matched), the controller 108 determines that the transmission destination address input by the email sender does not require approval of the email sender, and that the email sender has been approved to transmit emails unconditionally. Then, the controller 108 orders the image reader 101 to read the documents.

The images read by the image reader 101 are converted into an image data file at the image processor 102. The communication module 103 creates an email to which the image data file is attached, and transmits an email to the registered mail server (S605).

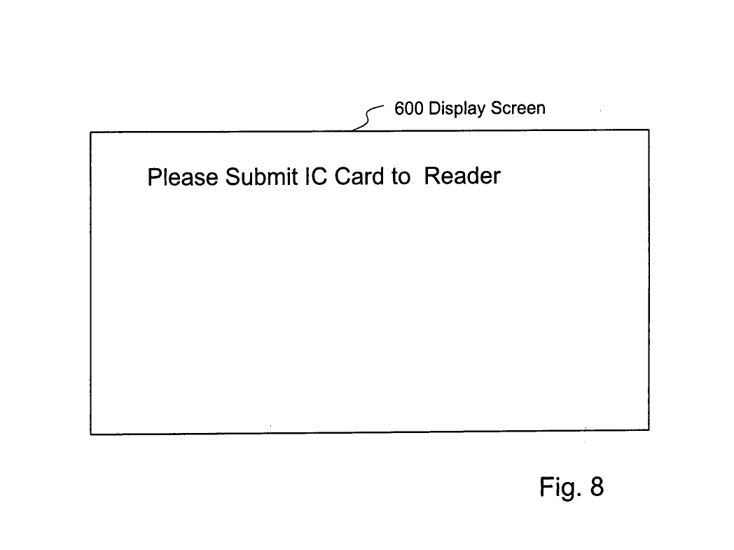

At S604, when the transmission destination address input by the email sender does not match any of the transmission destination addresses that are registered in the approved transmission destination information storage sector 300 (S604: Not matched), the controller 108 orders the operation panel 500 to display a message 600 (FIG. 8) which requests authentication of the email sender (S606).

When an IC card, or other type of identification, is provided by the email sender, the controller 108 orders the authentication information reader 107 to read the information from the IC card. The authentication information reader 107, upon receiving an order to read the IC card information, reads the email sender ID and the email sender authentication code. Next, the authentication information reader 107 compares the email sender ID and the email sender authentication code that are read from the IC card with the email sender ID code 401 and the email sender ID code 402 that are stored in the approved sender information storage sector 400, and authenticates the email sender (S607).

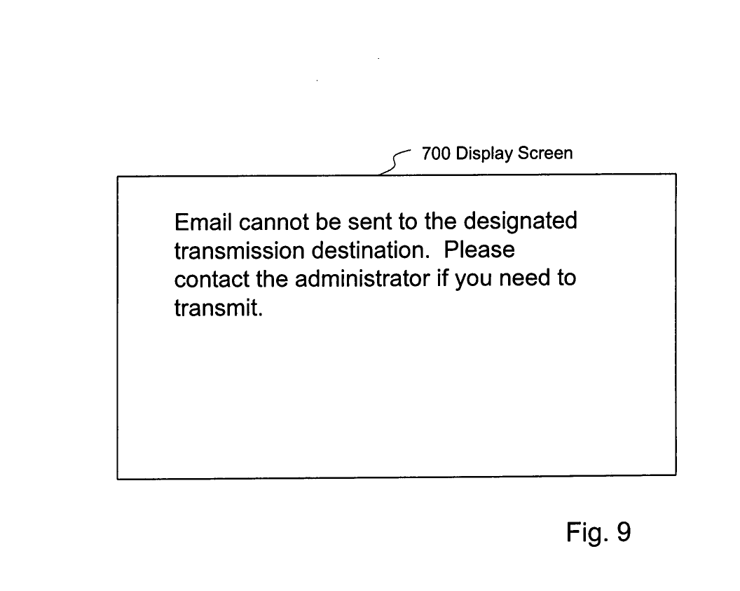

When the email sender is not registered as an approved email sender in the approved sender information storage sector 400 (S607: Not registered), the controller 108 displays a message 700 (FIG. 9) that the email transmission is not approved on the operation panel 500 and completes the email transmission processing (S608).

When the email sender has registered as an approved email sender in the approved sender information storage sector 400 (S607: Registered), the controller 108 compares the transmission destination address that is input by the email sender and the individual destination email addresses 403 that is registered in the approved sender information storage sector 400 (S609). When the transmission destination address that is input by the email sender is not registered in the approved sender information storage sector 400 (S609: Not matched), the controller 108 displays the message of non-approved email transmission on the operation panel 500, and completes email transmission processing (S608).

On the other hand, when the transmission destination address that is input by the email sender is registered in the approved sender information storage sector 400 (S609: Matched), the controller 108 orders the image reader 101 to read the documents. The image read by the image reader 101 is converted into an image data file at the image processor 102. The communication module 103 creates an email in which the image data is attached and transmits an email to the registered email server (S610).

After the email transmission is completed, the controller 108 stores the sender 801, the transmission destination 802, the transmission time and date 803 and the email title 804 in the transmission log storage sector 800 (S611) as the transmission log 810.

For example, when the transmission destination is designated within Company A 210, the email recipient can obtain the email transmitted from the MFP 100 to the mail server 212 by the email sender by accessing the mail server 212. Moreover, email recipients belonging to Company B 220, Company C 230 and Company D 240 can obtain the transmitted emails by accessing the mail servers 222, 232 and 242 respectively.

As stated above, according to the first embodiment, because only the people who have been approved to transmit the image data can transmit the image data outside of the company, unapproved disclosure of information outside the company can be prevented.

### Second Embodiment

As a network structure in which an image processing device of the second embodiment is connected, the block diagram and parts of approved transmission destination information used in the second embodiment are generally the same as those used in the image processing device of the first embodiment. Therefore, the explanation of similar components is omitted, and the different components will be explained hereafter.

As shown in FIG. 2, the MFP 900 of the second embodiment includes generally the same components as that described in connection with the first embodiment, with exceptions being an approved sender information storage sector 1000 and a transmission log storage sector 1200.

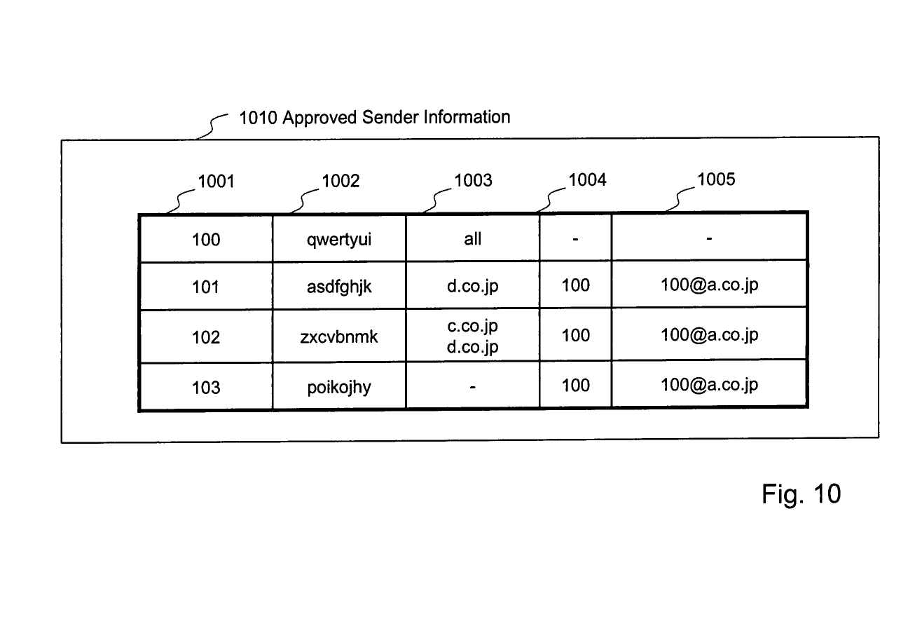

At the approved sender information storage sector 1000 of the memory 106, as shown in FIG. 10, approved sender information 1010 is registered. The approved sender information 1010 includes email sender ID codes 1001, email sender authentication ID codes 1002 and individual destination email addresses 1003 to which the email senders who have been approved to send emails using the MFP 900 can send emails. In addition, the approved sender information 1010 includes approver ID codes 1004 of a person or persons authorized to approve email transmissions (an approver), and an approver's email address 1005. The email sender ID codes 1001 include an identification code for each email sender such as an employee number. The email sender authentication ID codes 1002 are identification codes used for authentication of email senders. Also, when fingerprint authentication is used at the authentication information reader 107, fingerprint information will be registered as an ID code of an email sender. The individual destination email addresses 1003 form a list of the email addresses to which an email sender is approved to send emails with the attached data files that were created for each email sender.

The approver ID codes 1004 are ID codes of approvers who approve email transmissions when transmission destination addresses input by email senders are non-approved transmission destination email addresses. For example, when the ID of the manager of an email sender is registered as the approver ID code 1004, the email sender can transmit the emails to the transmission destination email addresses that are not approved by providing an IC card of the manager in which information of the registered ID is stored. The approver's email address 1005 is an email address to which emails are forwarded for approval rather prior to being sent to the non-approved transmission destination email addresses.

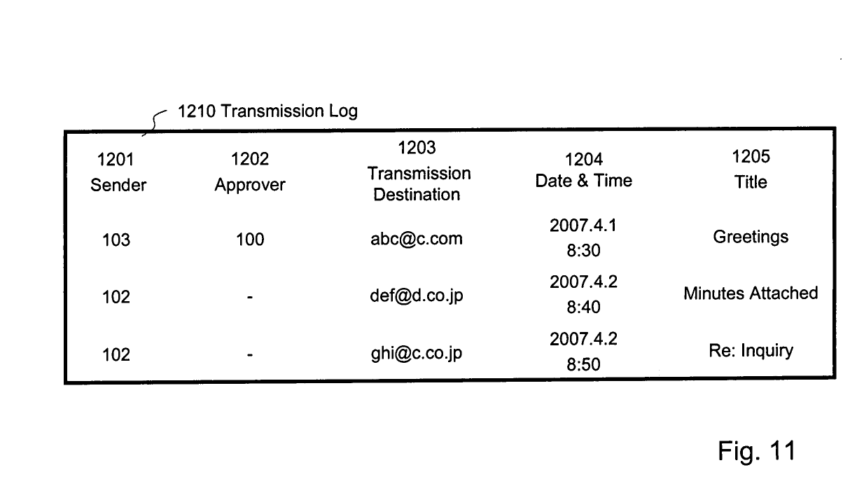

As shown in FIG. 11, the transmission log 1210 is stored in the transmission log storage sector 1200 of the memory 106 when the emails are transmitted to the approved transmission designations. For example, information on approvers 1202, as well as the senders 1201, the transmission destinations 1203, transmission times and dates 1204 and email titles 1205 or the like are stored at the transmission log 1210.

Hereafter the operation of the MFP 900 will be explained. At the MFP 900, the necessary information for the MFP 900 to communicate with the mail server 212, such as the IP address of the mail server 212, is registered by an administrator. Also, the approved transmission destination information 310 that include the transmission destination addresses in which authentication of the email sender is unnecessary, and the approved transmission destination information 1010, is registered.

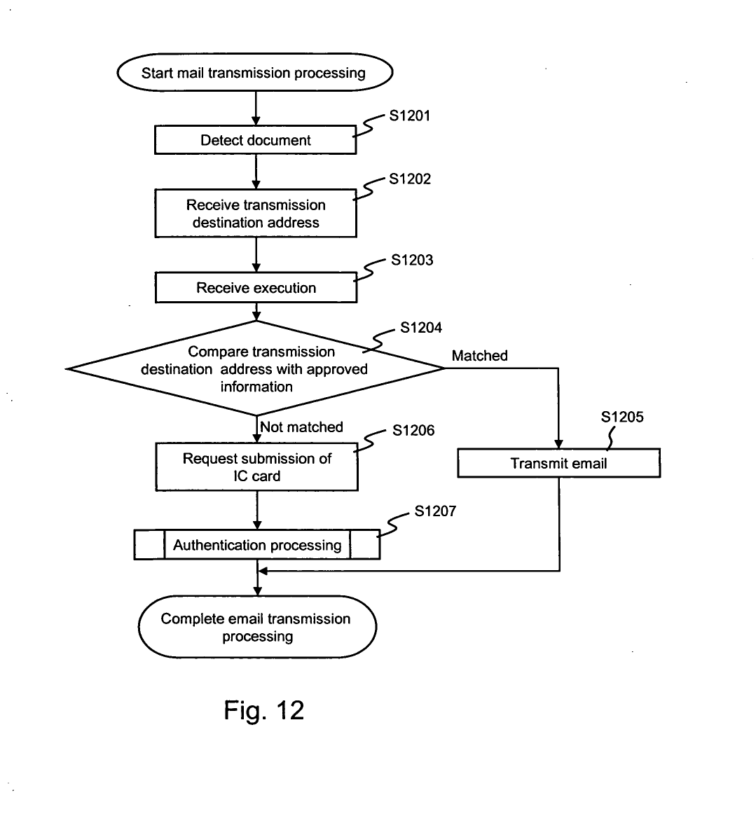

FIG. 12 is a flow diagram of email transmission processing from the reading of the document at the image reader 101 of the MFP 900 to the transmission of emails. When the image reader 101 of the MFP 900 detects the documents are sent by the email sender (S 1201), the controller 108 starts the preparation of the input reception of the transmission destination address(es) made by the email sender (S 1202). When the transmission destination address is input by the email sender in the address input field 502 of the operation panel 500 shown in FIG. 7, and the start key 505 of the operation panel 500 is pressed, the controller 108 starts the preparation of the reading documents (S 1203).

Next, the controller 108 compares the transmission destination addresses that are input by the email sender with the transmission destination addresses that are registered in the approved transmission destination information storage sector 300 in order (S1204). As a result, when one of the transmission destination addresses that is input by the email sender and one of the transmission destination addresses that are registered in the approved transmission destination information storage sector 300 are matched (S 1204: Matched), the controller 108 determines that the transmission destination addresses that were input by the email sender do not require authentication of the email sender, that is, the transmission destination address is considered as the email address that anyone can transmit emails unconditionally. Then, the controller 108 orders the image reader 101 to read the documents.

The images read by the image reader 101 are converted into an image data file at the image processor 102. The communication module 103 creates an email in which the image data file is attached, and transmits an email to the registered mail server (S 1205).

At S1204, when the transmission destination addresses that are input by the email sender and any of the transmission destination addresses that are registered in the approved transmission destination information storage sector 300 are not matched (S1204: Not matched), the controller 108 gives an order to the display 105 to display a message 600 (FIG. 8) which requests an authentication of the email sender on the operation panel 500. The display 105 that received the order displays the message for requesting submission of an IC card to the email sender on the operation panel 500 (S 1206).

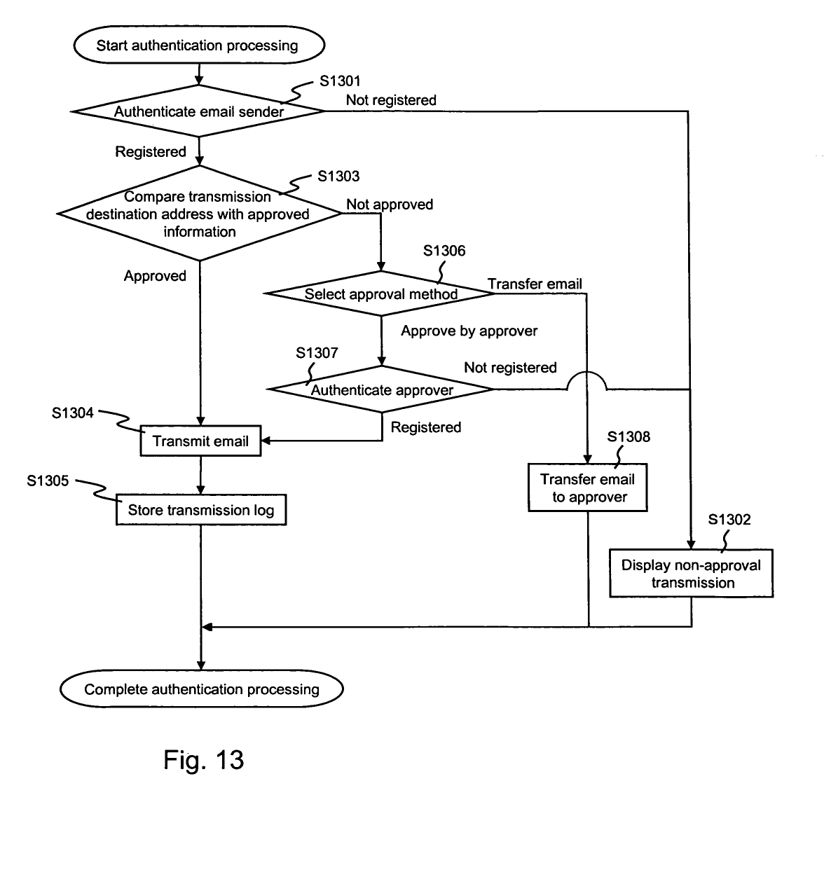

Next, the controller 108 starts the authentication processing according to the flow diagram shown in FIG. 13. When the IC card is provided by the email sender, the controller 108 orders the authentication information reader 107 to read the information registered in the IC card. The authentication information reader 107 that received an order to read the IC card information reads the email sender ID and email sender authentication code. Then, the authentication information reader 107 compares the email sender ID and the email sender identification code read from the IC card with the email sender ID codes 1001 and the email sender authentication ID codes 1002 that are registered at the approved sender information storage sector 1000, and authenticates the email sender (S1301).

When the email sender has not registered at the approved sender information storage sector 1000 (S1301 :Not registered), the controller 108 displays the message 700 (FIG. 9) that the transmission has not been approved on the operation panel 500 and completes the email transmission processing (S1302).

When the email sender has registered as an approved email sender in the approved sender information storage sector 1000 (S1301: Registered), the controller 108 compares the transmission destination address that is input by the email sender with the approved individual destination email addresses 1003 that are registered at the approved sender information storage sector 1000 (S1303). As a result, when the transmission destination address that is input by the email sender is registered in the approved sender information storage sector 1000 (S1303: Approved), the controller 108 orders the image reader 101 to read the documents. The image read by the image reader 101 is converted into an image data file at the image processor 102. The communication module 103 creates an email to which the image data is attached and transmits an email to the registered email server (S1304).

After the email transmission is completed, the controller 108 stores the sender 1201, the transmission destination 1203, the transmission time and date 1204 and the email title 1205 or the like in the transmission log storage sector 1200 as the transmission log 1210 (S1305).

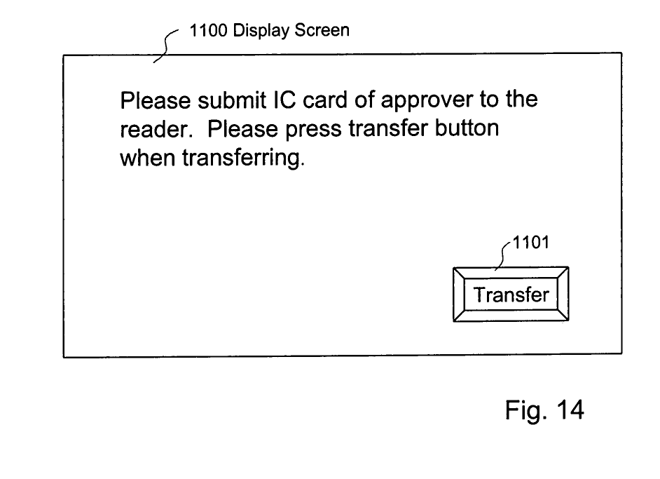

At S1303, as a result of comparison of the transmission destination address that was input by the email sender and the individual destination email addresses 1003 that are registered at the approved sender information storage sector 1000, when the email transmission designation address that was input by the email sender is not registered in the approved sender information storage sector 1000 (S1303: Not approved), the controller 108 displays the message illustrated in FIG. 14 to request authentication of the approver on the operation panel 500 (S1306).

When the IC card of the approver is submitted (S1306: Approve by approver), the controller 108 orders the authentication information reader 107 to read the information registered in the IC card. The authentication information reader 107 that received the order to read IC card information compares the approver's ID which is registered in the IC card with the approver ID codes 1004 registered in the approved sender information storage sector 1000, and performs the authentication of the IC card of the approver (S1307). When the approver is not registered at the approved sender information storage sector 1000 (S1307: Not registered), the controller 108 displays the message 700 of non-approved email transmission on the operation panel 500 (FIG. 9), and completes the email transmission processing (S1302).

When the approver was already registered at the approved sender information storage sector 1000, (S1307: Registered), the controller 108 orders the image reader 101 to read the documents. The images read by the image reader 101 are converted into the image data file at the image processor 102. The communication module 103 creates the email in which the image data file is attached, and transmits the email to the registered mail server (S1304).

After the email transmission is completed, the controller 108 stores the sender 1201, the approver 1202 if any, the transmission destination 1203, the transmission time and date 1204 and the email title 1205 or the like in the transmission log storage sector 1200 as the transmission log 1210.

At S1306, when the option of transferring, or forwarding, email to the approver is selected by the email sender, the controller 108 orders the communication module 103 to forward the email to the email address 1005 of the approver which is registered at the approved sender information storage sector 1000. In other words, when the user selects the transfer email option (S1306), the controller 108 reads the document out of the image reader 101 and converts it into image data. Then, the email is transmitted to the approver's email address which is registered in the email addresses 1005 (S1308). This operation is performed by pressing (or clicking) a transfer button 1101 displayed in a display screen 1100, as shown in FIG. 14. The communication module 103 which received the order forwards the email to the email address 1005 of the approver (S1308). This email forwarding to the approver can be used, for example, when the email sender wishes to transmit the email to non-approved email addresses or when the approver is not present and the IC card of the approver cannot be submitted.

The email recipient can obtain the email by accessing the mail server 212 when the email address that was transmitted to the mail server from the MFP 900 by the email sender is, for example, the transmission destination of Company A 210. Moreover, the email recipients of Company B 220, Company C 230 and Company D 240 can obtain the transmitted emails by accessing the mail servers 222, 232 and 242 respectively.

As stated above, according to the second embodiment, normally, a person who has not been approved to transmit the image data can transmit the image data to any companies other than Company A and Company B by obtaining approval from an authorized source of approval such as a manager.

In the first and second embodiments, the MFP was described as one example of the image processing device. However, the functionality described above can be adapted to be utilized with a scanner, copy machine, fax machine or other like devices other than an MFP. Moreover, in the aforementioned embodiments, an IC card is used to authenticate an email sender; however a biometrics type of authentication, such as fingerprint authentication or vein authentication, can be also used.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. An image processing device comprising:
an operation module configured to input designation settings of a designated transmission destination of image data;
an approved transmission destination information storage sector configured to store approved transmission destination information including transmission destinations that have been approved for receiving the image data; and
a controller configured to control transmission of the image data by comparing the designated transmission destination received at the operation module and the transmission destinations stored in the approved transmission destination information storage sector.

2. The image processing device of claim 1, wherein
the controller is configured to approve transmission of the image data to the designated transmission destination when the designated transmission destination matches one of the transmission destinations stored in the approved transmission destination information storage sector.

3. The image processing device of claim 1, further comprising:
an authentication information reader configured to obtain authentication information of an image data sender; and
an approved sender information storage sector configured to store image data sender authentication information of an image data sender and destination information including individual transmission destinations to which the image data sender has been approved to transmit the image data, wherein
the controller is configured to approve transmission of the image data to the designated transmission destination when the obtained authentication information of the image data sender and the designated transmission destination match the image data sender authentication information and one of the individual transmission destinations stored in the approved sender information storage sector if the designated transmission destination does not match one of the transmission destinations stored in the approved transmission destination information storage sector.

4. An image processing device comprising:
an operation module configured to input designation settings of a designated transmission destination of image data;
an authentication information reader configured to obtain authentication information of an image data sender;
a memory configured to store approved transmission destinations that have been approved for receiving the image data and approved individual transmission destinations to which the image data sender has been approved to transmit the image data;
a controller configured to control transmission of the image data by comparing the designated transmission destination received at the operation module with the approved transmission destinations or the approved individual transmission destinations stored in the memory, wherein
the controller is configured to request authentication of an approver designated to approve the designated transmission destination when the designated transmission destination does not match any of the approved transmission destinations and the approved individual transmission destinations stored in the memory.

5. The image processing device according to claim 4, wherein
the controller is further configured to convert input data into the image data and to cause the image data to be transmitted to an email address of the approver, which is stored in the memory, when the image data sender selects a transfer email to approver option.

6. The image processing device according to claim 4, wherein the controller is further configured to transfer an email, including the image data as an attachment, to the approver for approval prior to transmission of the email to the designated transmission destination.

7. The image processing device according to claim 4, wherein the controller is configured to order the authentication information reader to read identification information of the approver and to compare the identification information to approver identification information stored in the memory.

8. The image processing device according to claim 4, further comprising an image reader configured to scan in the image data when the controller determines that the designated transmission destination received at the operation module matches one of the approved transmission destinations approved for receiving the image data stored in the memory.

9. The image processing device according to claim 4, further comprising an image reader configured to
scan in the image data after the controller receives the authentication of the approver designated to approve the designated transmission destination, and
scan in the image data for transmission to an email address of the approver after the controller receives a transfer email to approver request from the image data sender.

10. The image processing device according to claim 4, further comprising an image reader configured to scan in the image data prior to transmission of an email including the image data as an attachment to the approver for transmission approval.

11. The image processing device according to claim 4, further comprising a display configured to display a message requesting the authentication of the approver when the controller requests the authentication of the approver, the display being integrated with the operation module as a single unit.

12. A method of transmitting image data as an attachment to an email, comprising:
receiving an input transmission destination email address from an email sender to which an image data file is to be transmitted as an email attachment;
comparing the input transmission destination email address to a list of approved transmission destination email addresses stored in a memory;
if the comparing of the input transmission destination email address to a list of approved transmission destination email addresses results in a match,
scanning in the image data file, and
transmitting the image data file to the input transmission destination email address.

13. The method of claim 12, further comprising displaying a non-approval transmission message if the comparing of the input transmission destination email address to a list of approved transmission destination email addresses stored in a memory does not result in a match.

14. The method of claim 12, further comprising:
if the comparing of the input transmission destination email address to a list of approved transmission destination email addresses does not result in a match,
requesting authentication from the email sender,
reading input email sender identification information to determine if the email sender is registered as an approved sender,
if the email sender is registered as an approved sender, comparing the input transmission destination email address to a list of stored approved sender individual transmission destination email addresses to determine if the input transmission destination email address is registered, and
if the comparing of the input transmission destination email address to a list of stored approved sender individual transmission destination email addresses results in a match, scanning in the image data file and transmitting the image data file to the input transmission destination email address.

15. The method of claim 14, further comprising:
if the comparing of the input transmission destination email address to a list of stored approved sender individual transmission destination email addresses does not result in a match,
requesting authentication information from an approver, and
performing the scanning in of the image data file once the approver provides approver authentication information.

16. The method of claim 12, further comprising:
if the comparing of the input transmission destination email address to a list of approved transmission destination email addresses does not result in a match,
requesting transmission approval from an approver,
receiving a transfer email to approver request from the email sender,
performing the scanning in of the image data file,
transmitting the image data file to the approver as an email attachment,
receiving transmission approval from the approver, and
performing the transmitting of the image data file to the input transmission destination email address.
